(19) United States
(12) Patent Application Publication
(10) Pub. No.: US 2026/0222186 A1
(43) Pub. Date: Jul. 30, 2026

(54) QUANTUM KEY DISTRIBUTION DEVICE, QUANTUM KEY DISTRIBUTION SYSTEM, AND QUANTUM KEY DISTRIBUTION METHOD

(71) Applicant: NEC Corporation, Tokyo (JP)

(72) Inventors: Tetsuo KAWAKAMI, Tokyo (JP); Ken-ichiro YOSHINO, Tokyo (JP); Toshihiko OKAMURA, Tokyo (JP); Wakako YASUDA, Tokyo (JP)

(73) Assignee: NEC Corporation, Tokyo (JP)

(21) Appl. No.: 19/149,182

(22) PCT Filed: Mar. 10, 2023
(86) PCT No.: PCT/JP2023/009279

§ 371 Date: Jul. 18, 2025

(51) Int. Cl. H04L 9/08

(52) U.S. Cl. CPC H04L 9/0852

(57) ABSTRACT

A first quantum key delivery device (10) comprises: a light source (11) that outputs light; a branch unit that causes light output from the light source (11) to branch to first light and second light; a random number generation unit (13) that generates a random number on the basis of the first light caused to branch by the branch unit (12); a modulation unit (14) that modulates the second light caused to branch by the branch unit (12) on the basis of the random number generated by the random number generation unit (13); and an optical transmission unit (15) that transmits the second light modulated by the modulation unit (14) as a quantum optical signal to another quantum key delivery device.

### TECHNICAL FIELD

The present disclosure relates to a quantum key distribution device, a quantum key distribution system, and a quantum key distribution method.

### BACKGROUND ART

In recent years, quantum cryptography has been studied as an encryption technique for ensuring security of communication. In quantum cryptography, quantum key distribution (Quantum Key Distribution; QKD) enables secure sharing of an encryption key between bases.

For quantum key distribution, discrete quantum key distribution (Discrete Variable QKD; DV-QKD) in which quantum key distribution is performed using a photon detector and continuous quantum key distribution (Continuous-Variable Quantum Key Distribution; CV-QKD) in which quantum key distribution is performed using coherent detection have been known. As a technique related to CV-QKD, for example, PTL 1 has been known.

### CITATION LIST

### Patent Literature

PTL 1: Published Japanese Translation of PCT International Publication for Patent Application, No. 2019-522394

### SUMMARY OF INVENTION

### Technical Problem

An object of a quantum key distribution system that performs quantum key distribution by CV-QKD or the like is to share a random number sequence without permitting eavesdropping between two parties. However, a random number generation device that performs optical modulation and error correction to share the random number sequence is indispensable for the quantum key distribution system. In the related technology, since a large random number generation device using thermal noise measurement or the like is used, there is a problem that a configuration for quantum key distribution becomes large or complicated.

In view of the above problems, an object of the present disclosure is to provide a quantum key distribution device, a quantum key distribution system, and a quantum key distribution method capable of suppressing an increase in size and complexity.

### Solution to Problem

A quantum key distribution device according to the present disclosure includes a light source for outputting light, a branch means for branching the light output from the light source into first light and second light, a random number generation means for generating a random number based on the first light, a modulation means for modulating the second light based on the random number, and an optical transmission means for transmitting the modulated second light as a quantum optical signal to another quantum key distribution device.

A quantum key distribution device according to the present disclosure includes an optical reception means for receiving a quantum optical signal from another quantum key distribution device, a light source for outputting local light, a branch means for branching the local light output from the light source into first local light and second local light, a random number generation means for generating a random number based on the first local light, and a detection means for coherently detecting the received quantum optical signal based on the second local light and the random number.

A quantum key distribution system according to the present disclosure includes a first quantum key distribution device and a second quantum key distribution device that are communicatively connected, in which the first quantum key distribution device includes a light source for outputting light, a branch means for branching light output from the light source into first light and second light, a random number generation means for generating a random number based on the first light, a modulation means for modulating the second light based on the random number, and an optical transmission means for transmitting the modulated second light as a quantum optical signal to the second quantum key distribution device.

A quantum key distribution system according to the present disclosure includes a first quantum key distribution device and a second quantum key distribution device that are communicatively connected, in which the second quantum key distribution device includes an optical reception means for receiving a quantum optical signal from the first quantum key distribution device, a light source for outputting local light, a branch means for branching the local light output from the light source into first local light and second local light, a random number generation means for generating a random number based on the first local light, and a detection means for coherently detecting the received quantum optical signal based on the second local light and the random number.

A quantum key distribution method in a quantum key distribution device according to the present disclosure includes branching light output from a light source into first light and second light, generating a random number based on the first light, modulating the second light based on the random number, and transmitting the modulated second light as a quantum optical signal to another quantum key distribution device.

A quantum key distribution method in a quantum key distribution device according to the present disclosure, includes receiving a quantum optical signal from another quantum key distribution device, branching the local light output from the light source into first local light and second local light, generating a random number based on the first local light, and coherently detecting the received quantum optical signal based on the second local light and the random number.

### Advantageous Effects of Invention

According to the present disclosure, it is possible to provide a quantum key distribution device, a quantum key distribution system, and a quantum key distribution method capable of suppressing an increase in size and complexity.

### BRIEF DESCRIPTION OF DRAWINGS

FIG. 1 is a configuration diagram illustrating a schematic configuration of a first quantum key distribution device according to an example embodiment.

FIG. 2 is a configuration diagram illustrating a schematic configuration of a second quantum key distribution device according to the example embodiment.

FIG. 3 is a block diagram illustrating a configuration example of a quantum key distribution system according to a first example embodiment.

FIG. 4 is a diagram illustrating an example of a processing procedure in which the quantum key distribution system according to the first example embodiment performs quantum key distribution.

FIG. 5 is a diagram illustrating an example of random number generation by coherent detection in a vacuum state according to the first example embodiment.

FIG. 6 is a block diagram illustrating a configuration example of a quantum communication unit of a transmitter and a quantum communication unit of a receiver according to the first example embodiment.

FIG. 7 is a flowchart illustrating an operation example of the quantum key distribution system according to the first example embodiment.

FIG. 8 is an I-Q plan view illustrating a phase in a case where a phase modulator according to the first example embodiment modulates light.

FIG. 9 is a block diagram illustrating a configuration example of the quantum key distribution system according to the second example embodiment.

FIG. 10 is a block diagram illustrating a configuration example of a quantum communication unit of a receiver according to the second example embodiment.

### EXAMPLE EMBODIMENT

Hereinafter, example embodiments of the present disclosure will be described with reference to the drawings, but the following example embodiments do not limit the disclosure according to the claims. Not all combinations of features described in the example embodiments are essential to the solution of the present disclosure. In the drawings, the same elements are denoted by the same reference numerals, and redundant description will be omitted as necessary.

### Study for Achieving Example Embodiments

As described above, the quantum key distribution system requires a random number generation device, and the inventor has studied a configuration of the quantum key distribution system including the random number generation device. The random number generation device used in the related quantum key distribution system mainly uses a physical phenomenon not related to quantum optical communication, such as thermal noise measurement, and the QKD optical communication device and the random number generation device are not shared and are configured as a system. For this reason, the inventors have found a problem that the related quantum key distribution system is large and complicated.

Therefore, in the example embodiment, the configuration of the random number generation device and the configuration of the QKD optical communication device can be made common. According to quantum mechanics, since a phase and an amplitude cannot be determined simultaneously, a phase amplitude in a vacuum state with zero photon number takes a random value around the origin. Based on this principle, a method for generating a random number is conceivable in which a vacuum state is interfered with a local oscillator light having a high intensity (local oscillator light), and a phase amplitude in a vacuum state is read by coherent detection. On the other hand, in the CV-QKD, signal light output from a light source in a transmitter is attenuated until quantum properties are visible in order to prevent eavesdropping on a transmission path, and is transmitted as quantum light to a receiver. Quantum light having weak intensity received in the receiver interferes with local light having high intensity, and phase amplitude of the quantum light is read by coherent detection to generate a quantum key. Therefore, in the example embodiment, a transmission light source of the CV-QKD optical communication device and a light source for random number generation by coherent detection in a vacuum state are made common, and signal light of the transmission light source of the CV-QKD optical communication device, which is supposed to be attenuated and discarded, is used for random number generation, thereby achieving a small and simple quantum key distribution system.

### OVERVIEW OF EXAMPLE EMBODIMENT

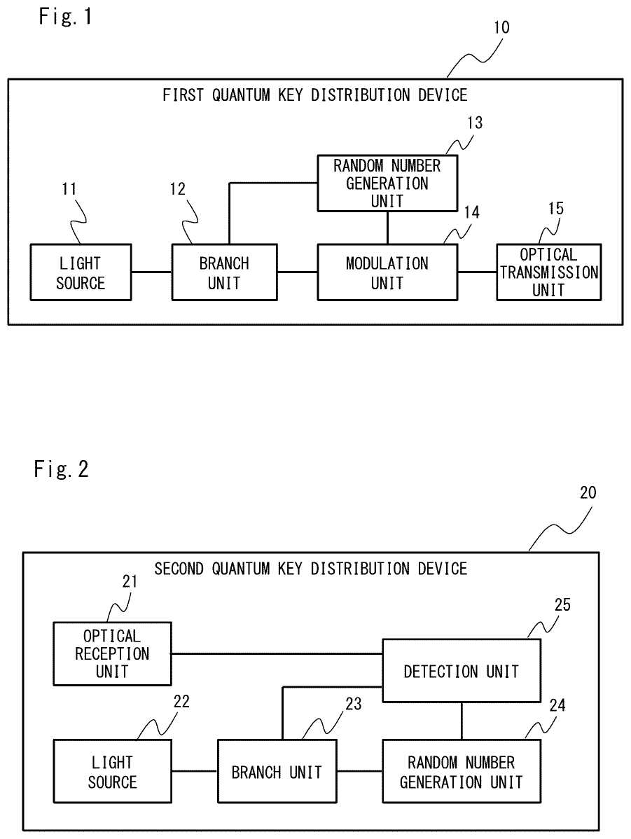

FIG. 1 illustrates a schematic configuration of a first quantum key distribution device 10 according to an example embodiment, and FIG. 2 illustrates a schematic configuration of a second quantum key distribution device 20 according to the example embodiment. For example, the first quantum key distribution device 10 and the second quantum key distribution device 20 are communicably connected to configure a quantum key distribution system. The first quantum key distribution device 10 is a transmitter for QKD (QKD transmitter), and the second quantum key distribution device 20 is a receiver for QKD (QKD receiver). The first quantum key distribution device 10 may configure a quantum key distribution system with a receiver for QKD (for example, a receiver having no common light source) having a configuration different from that of the second quantum key distribution device 20. The second quantum key distribution device 20 may configure a quantum key distribution system with a transmitter for QKD (for example, a transmitter having no common light source) having a configuration different from that of the first quantum key distribution device 10.

As illustrated in FIG. 1, the first quantum key distribution device 10 includes a light source 11, a branch unit 12, a random number generation unit 13, a modulation unit 14, and an optical transmission unit 15. The light source 11 outputs light. The branch unit 12 branches the light output from the light source 11 into a first light and a second light. The random number generation unit 13 generates a random number based on the first light branched from the branch unit 12. For example, the random number generation unit 13 generates a random number by coherent detection using the first light as the local light.

The modulation unit 14 modulates the second light branched from the branch unit 12 based on the random number generated by the random number generation unit 13. For example, the modulation unit 14 performs phase modulation by a Dual Polarization Quadrature Phase Shift Keying (DP-QPSK) method. The optical transmission unit 15 transmits the second light modulated by the modulation unit 14 to, for example, the second quantum key distribution device 20 as a quantum optical signal for QKD. For example, the optical transmission unit 15 transmits weak light obtained by attenuating the light intensity of the modulated second light to a predetermined intensity.

As illustrated in FIG. 2, the second quantum key distribution device 20 includes an optical reception unit 21, a light source 22, a branch unit 23, a random number generation unit 24, and a detection unit 25. The optical reception unit 21 receives a quantum optical signal for QKD from the first quantum key distribution device 10, for example. The light source 22 outputs local light. The branch unit 23 branches the local light output from the light source 22 into a first local light and a second local light.

The random number generation unit 24 generates a random number based on the first local light branched from the branch unit 23. For example, the random number generation unit 24 generates a random number by coherent detection using the first local light. The detection unit 25 coherently detects the quantum optical signal received by the optical reception unit 21 based on the second local light branched from the branch unit 23 and the random number generated by the random number generation unit 24. For example, the detection unit 25 coherently detects the received quantum optical signal based on the second local light phase-modulated by the random number.

As described above, in the example embodiment, in the first quantum key distribution device which is the transmitter for QKD, the light source used for random number generation by the random number generation unit and the light source used for transmission by the modulation unit are made common. In the second quantum key distribution device which is a receiver for QKD, the local light source used for random number generation by the random number generation unit and the local light source used for coherent detection by the detection unit are made common. This makes it possible to miniaturize and simplify the quantum key distribution device for QKD on the transmitter side or the receiver side.

### First Example Embodiment

Next, a first example embodiment of the present disclosure will be described. In the present example embodiment, an example will be described in which light sources used by a QKD optical communication device and a random number generation device are shared in a transmitter that performs quantum key transport.

### <Configuration of Quantum Key Distribution System>

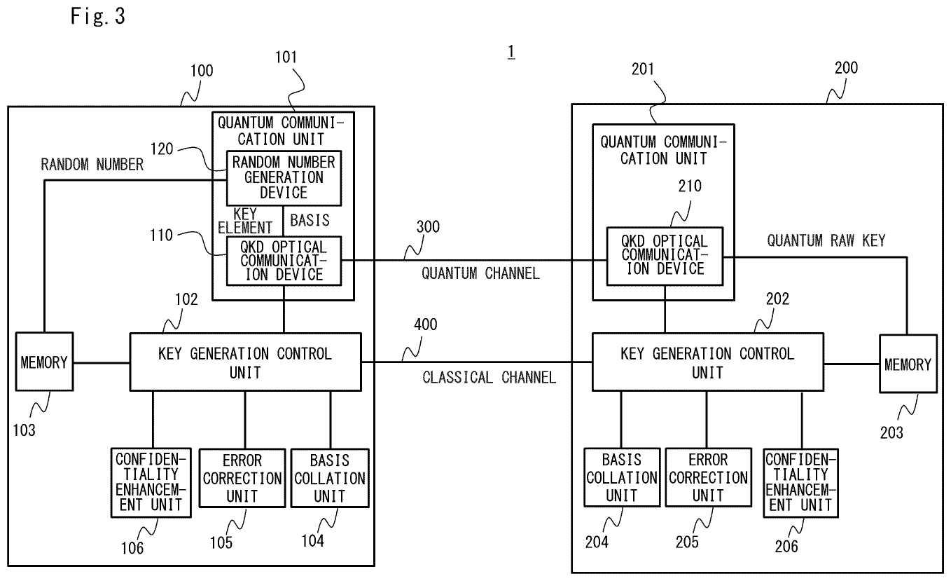

FIG. 3 is a block diagram illustrating a configuration example of a quantum key distribution system 1 according to the present example embodiment.

As illustrated in FIG. 3, the quantum key distribution system 1 includes a transmitter 100 and a receiver 200. The quantum key distribution system 1 is a system that performs quantum key distribution by the transmitter 100 and the receiver 200. In quantum key distribution, a random number sequence serving as an element of an encryption key is transmitted using quantum light. This enables secure key sharing between the transmitter 100 and the receiver 200. The quantum key distribution system 1 performs quantum key distribution using light whose intensity is reduced to such an extent that quantum behavior can be confirmed. As a result, it is possible to quantum mechanically guarantee that the encryption key is not leaked, and to achieve high confidentiality.

For example, the transmitter 100 is a transmission device for QKD that performs quantum key distribution by CV-QKD. The transmitter 100 corresponds to an example of a first quantum key carrier device (first communication device). The receiver 200 is a reception device for QKD that performs quantum key distribution by CV-QKD. The receiver 200 corresponds to an example of a second quantum key carrier device (second communication device).

The transmitter 100 and the receiver 200 are communicatively connected by a quantum channel 300 and a classical channel 400. The quantum channel 300 is associated with an example of a first channel. The classical channel 400 is associated with an example of a second channel.

The quantum channel 300 is a communication channel for transmitting and receiving weak light (quantum light) transmitted from the transmitter 100 to the receiver 200. The weak light mentioned here is, for example, light that behaves in a quantum manner with optical power of about 1 photon/bit or less. The quantum channel 300 is configured using, for example, an optical fiber.

The classical channel 400 is a channel with higher reliability than the quantum channel 300. The high reliability of the communication channel means, for example, that a bit error rate (Bit Error Rate; BER) is low. Hereinafter, for convenience of description, a communication channel without an error is assumed as the classical channel 400. The absence of the error mentioned herein may mean that all communication errors can be corrected by error correction or that all errors can be detected and retransmitted by error detection. A communication scheme in the classical channel 400 is not limited to a specific scheme. For example, the classical channel 400 may include the same optical fiber as the quantum channel 300, or may include a transmission path different from the quantum channel 300.

Both notation of “transmission” of the transmitter 100 and notation of “reception” of the receiver 200 are for convenience of description, and data may be transmitted from the receiver 200 to the transmitter 100. In particular, the receiver 200 transmits information for performing processing in quantum key distribution to the transmitter 100 using the classical channel 400.

The transmitter 100 includes a quantum communication unit 101, a key generation control unit 102, a memory 103, a basis collation unit 104, an error correction unit 105, and a confidentiality enhancement unit 106. In addition, the quantum communication unit 101 includes a QKD optical communication device 110 and a random number generation device 120.

The random number generation device 120 generates a random number used by the QKD optical communication device 110 and the key generation control unit 102. For example, the random number generation device 120 generates a random number by a random number generation method using coherent detection, outputs the generated random number to the QKD optical communication device 110, and stores the random number in the memory 103.

The random number generation device 120 generates two random number sequences as bit sequences. One of these two random number sequences is used as a bit sequence serving as the element of the quantum key. This random number sequence is also referred to as a first random number sequence or a first bit sequence. A bit sequence obtained by selecting some bits of the first random number sequence is used as a quantum key. The other of the two random number sequences indicates a basis to be selected in a case where each bit in the first random number sequence is transmitted. This random number sequence is also referred to as a second random number sequence or a second bit sequence. The second random number sequence can be said to be information indicating the basis used for encoding the bit sequence serving as the element of the quantum key. For this reason, the second random number sequence is also referred to as basis information. The second random number sequence can be said to be information indicating the basis selected by the transmitter 100 at the time of encoding the bit sequence to be the element of the quantum key. For this reason, the second random number sequence is also referred to as basis selection information or basis selection information in the transmitter 100.

The QKD optical communication device 110 is a transmission device that transmits weak light (quantum optical signal) for performing quantum key distribution by CV-QKD. The QKD optical communication device 110 of the transmitter 100 is communicably connected to the QKD optical communication device 210 of the receiver 200 via the quantum channel 300. For example, the QKD optical communication device 110 modulates light to be transmitted by a modulation scheme similar to that of an optical transmitter used in coherent communication. The QKD optical communication device 110 modulates the weak light using the random number sequence (first random number sequence) serving as the element of the key generated by the random number generation device 120 and the random number sequence (second random number sequence) serving as the basis selection information, and transmits the modulated weak light to the receiver 200 via the quantum channel 300. The QKD optical communication device 110 modulates weak light and transmits the weak light to the receiver 200 under the control of the key generation control unit 102.

In a case where a receiver used by an eavesdropper receives a quantum light from the transmitter 100, the basis selection information for decoding a code cannot be received before the code by the quantum light is received. Therefore, it is impossible to keep the quantum light in the state of the quantum light without leaving a trace from the quantum unreplicability theorem, and the receiver of the eavesdropper randomly selects one of the two bases and decodes the code by the quantum light grafted. In this case, the receiver used by the eavesdropper performs decoding using a basis different from the basis used by the transmitter 100 with a probability of 1/2, and cannot perform accurate decoding. The quantum state changes due to measurement of different bases, and eavesdropping can be detected, in such a way that eavesdropping cannot be performed.

The key generation control unit 102 controls each unit of the transmitter 100 to perform various processing. In particular, the key generation control unit 102 controls the basis collation unit 104, the error correction unit 105, and the confidentiality enhancement unit 106 in addition to the quantum communication unit 101 including the QKD optical communication device 110 and the random number generation device 120. The key generation control unit 102 can be implemented on a processor such as a central processing unit (CPU) under a program control by software.

The key generation control unit 102 of the transmitter 100 is communicably connected to the key generation control unit 202 of the receiver 200 through the classical channel 400. The classical channel 400 is used to exchange information necessary in a case where the transmitter 100 and the receiver 200 perform processing of basis collation (basis collation units 104 and 204), processing of error correction (error correction units 105 and 205), and the like.

The memory 103 stores various data. For example, the memory 103 stores a random number generated by the random number generation device 120. This random number is accessed from the key generation control unit 102 in a process of generating the quantum key. The memory 103 can be implemented using a storage device included in the transmitter 100.

The basis collation unit 104, the error correction unit 105, and the confidentiality enhancement unit 106 are key distillation units that perform key distillation processing based on the random number stored in the memory 103. The basis collation unit 104 is a basis collation means that performs basis collation processing together with the basis collation unit 204 of the receiver 200. For example, the basis collation unit 104 performs basis collation processing using the classical channel 400 and sifts the bits (key elements) of the random number sequence. The random number sequence obtained by the processing performed by the basis collation unit 104 is also referred to as a selection key.

The error correction unit 105 is an error correction means that performs error correction processing together with the error correction unit 205 of the receiver 200. For example, the error correction unit 105 performs error correction processing on the selection key obtained by basis collation by using the classical channel 400, and ideally outputs the same selection key as that of the receiver 200.

The confidentiality enhancement unit 106 is a confidentiality enhancement means that performs confidentiality enhancement processing together with the confidentiality enhancement unit 206 of the receiver 200. The confidentiality enhancement unit 106 performs confidentiality enhancement processing on the selection key obtained by the error correction, extracts only a random number sequence having no possibility of eavesdropping, and ideally outputs the same random number sequence as that of the receiver 200. The random number sequence output by the confidentiality enhancement unit 106 is used as a quantum key.

The functions of the basis collation unit 104, the error correction unit 105, and the confidentiality enhancement unit 106, or some of them may be implemented by a CPU or a graphics processing unit (GPU) executing software. Alternatively, the basis collation unit 104, the error correction unit 105, and the confidentiality enhancement unit 106, or some of them may be implemented using hardware such as a field programmable gate array (FPGA) or an application specific integrated circuit (ASIC).

The receiver 200 includes a quantum communication unit 201 including a QKD optical communication device 210, a key generation control unit 202, a memory 203, a basis collation unit 204, an error correction unit 205, and a confidentiality enhancement unit 206.

The QKD optical communication device 210 is a reception device that receives weak light (quantum optical signal) for performing quantum key distribution by CV-QKD. For example, the QKD optical communication device 210 detects received light by coherent detection similar to that of the optical receiver used in coherent communication. The QKD optical communication device 210 receives weak light from the transmitter 100 via the quantum channel 300 and coherently detects the received weak light. The QKD optical communication device 210 outputs the bit sequence obtained by the coherent detection as a quantization raw key and stores the bit sequence in the memory 203. The QKD optical communication device 210 is controlled by the key generation control unit 202.

The key generation control unit 202 controls each unit of the receiver 200 to perform various processing. In particular, the key generation control unit 202 controls the basis collation unit 204, the error correction unit 205, and the confidentiality enhancement unit 206 in addition to the QKD optical communication device 210. The key generation control unit 202 can be implemented by software on a processor under program control such as a CPU, for example.

The memory 203 stores various data. For example, the memory 203 stores a quantization raw quantum key output from the QKD optical communication device 210. This quantization raw key is accessed from the key generation control unit 202 in a process of generating the quantum key. The memory 203 can be implemented using a storage device included in the receiver 200.

The basis collation unit 204, the error correction unit 205, and the confidentiality enhancement unit 206 are key distillation units that perform key distillation processing based on a quantum raw key stored in the memory 203. The basis collation unit 204 is a basis collation means that performs basis collation processing together with the basis collation unit 104 of the transmitter 100. For example, similarly to the basis collation unit 104 of the transmitter 100, the basis collation unit 204 performs basis collation processing using the classical channel 400 and sifts the bits (quantization raw keys) of the random number sequence. The random number sequence output by the basis collation unit 204 is associated with an example of the selection key.

The error correction unit 205 is an error correction means that performs error correction processing together with the error correction unit 105 of the transmitter 100. For example, similarly to the error correction unit 105 of the transmitter 100, the error correction unit 205 performs the error correction processing on the selection key obtained by the basis collation using the classical channel 400, and ideally outputs the same selection key as the error correction unit 105 of the transmitter 100.

The confidentiality enhancement unit 206 is a confidentiality enhancement means that performs confidentiality enhancement processing together with the confidentiality enhancement unit 106 of the transmitter 100. Similarly to the confidentiality enhancement unit 106 of the transmitter 100, the confidentiality enhancement unit 206 performs the confidentiality enhancement processing on the selection key obtained by the error correction, extracts only a random number sequence having no possibility of eavesdropping, and ideally outputs the same random number sequence as the confidentiality enhancement unit 106 of the transmitter 100. The random number sequence output by the confidentiality enhancement unit 206 is used as a quantum key.

The functions of the basis collation unit 204, the error correction unit 205, and the confidentiality enhancement unit 206, or some of them may be implemented by a CPU or a GPU executing software. Alternatively, the basis collation unit 204, the error correction unit 205, and the confidentiality enhancement unit 206, or some of them may be implemented using hardware such as FPGA or ASIC.

### <Processing Procedure of Quantum Key Distribution>

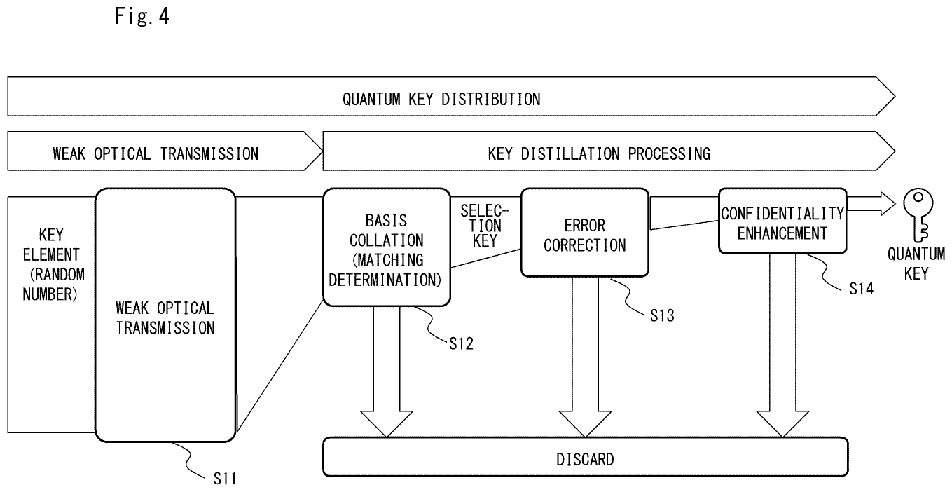

FIG. 4 is a diagram illustrating an example of a processing procedure in which the quantum key distribution system 1 according to the present example embodiment performs quantum key distribution. As illustrated in FIG. 4, the quantum key distribution processing step performed by the quantum key distribution system 1 includes four steps of weak light transmission (photon transmission) (S11), basis collation (matching determination) (S12), error correction (S13), and confidentiality enhancement (S14). The basis collation (S12), the error correction (S13), and the confidentiality enhancement (S14) are included in the key distillation processing.

First, in the weak light transmission (S11), the QKD optical communication device 110 of the transmitter 100 transmits a random number sequence of a bit value (binary value) to be an element of the quantum key by the Dual Polarization Quadrature Phase Shift Keying (DP-QPSK) modulation method in the optical communication in the quantum channel 300. At that time, the QKD optical communication device 110 randomly selects one of the two bases for each bit to be a quantum key element, modulates the signal light using the selected basis, and expresses a bit value to be a quantum key element. The basis here is a combination of two states among the states used to express data in modulation. The selection of the basis is to select any of a plurality of bases as a basis used for modulation. As described later, the quantum key distribution system 1 uses a combination of a phase of 0° and a phase of 180° in phase modulation as one basis, and uses a combination of a phase of 90° and a phase of 270° as another basis.

Since the quantum key distribution system 1 distributes a quantum key by CV-QKD, the QKD optical communication device 210 of the receiver 200 measures a state of an optical electric field from weak light received via the quantum channel 300 by coherent detection to generate an encryption key. In the coherent detection, signal light is filtered spatially, temporally, and wavelength-wise by interfering the signal light with local light, and a signal state is read out. As the local light here, laser light from a laser light source included in the receiver 200 is used.

In the case of DV-QKD which is another quantum key distribution method, the receiver generates an encryption key from the presence or absence of photons using a photon detector. On the other hand, in the case of CV-QKD, the system can be achieved by a general optical component, and can be achieved at a lower cost than DV-QKD using a photon detector. In CV-QKD, a quantum key carrier system in which general communication light and a transmission path coexist can be achieved by filtering using local light. In the coherent detection, the signal light can obtain a light amplification effect by causing local light having strong optical power to interfere with the signal light. Therefore, even in a weak state where the power of the signal light is 1 photon/bit or less, the signal light can be detected using a general photodetector (Photodetector).

Next, in the basis collation (S12), the basis collation unit 204 of the receiver 200 reads the information encoded (encoded) with the weak quantum light transmitted through the quantum channel 300 in synchronization with clock timing in the basis collation unit 104 of the transmitter 100 and the basis collation unit 204 of the receiver 200. Encoding information into light or a signal as used herein means modulating the light or the signal so as to indicate the information. The basis collation unit 204 stores the phase and amplitude of the read quantum light in the memory 203. The basis collation unit 204 receives the basis selection information from the basis collation unit 104 of the transmitter 100 through the classical channel 400, projects the detection result on an I axis or a Q axis with respect to the phase and the amplitude of the read quantum light, and converts the phase and the amplitude into a bit value of 0 or 1. As a result, the basis collation unit 204 acquires a bit value to be the element of the quantum key from the detection result. In a case where acquiring the bit value from the detection result, the basis collation unit 204 sets a constant threshold to the detected value, and discards, as a post-section, the bit for which an absolute value of the detection value is smaller than the threshold because the amount of information that can be obtained by the eavesdropper is large and the safety cannot be secured. Here, discarding the bit means not using the bit for a quantum key.

In a case where the above basis collation (S12) is completed, the quantum key distribution system 1 performs error correction (S13) and confidentiality enhancement (S14). In the error correction (S13), the error correction unit 105 of the transmitter 100 and the error correction unit 205 of the receiver 200 disclose a part of the bits for which the basis comparison has been completed in the classical channel 400 to measure an error rate, and further disclose a part of the bits according to the measured error rate to use for correction, thereby sharing the same bit sequence among the transmitters and receivers.

In the confidentiality enhancement (S14), the confidentiality enhancement unit 206 of the receiver 200 measures noise and loss in the quantum channel 300, estimates the maximum amount of information obtained by an eavesdropper in a case where it is assumed that there is the eavesdropper, and randomly discards a part of the bit sequence in such a way that the amount of information obtained by the eavesdropper becomes 0. As a result, the transmitter 100 and the receiver 200 can share a random number sequence that is quantum mechanically guaranteed not to be eavesdropped.

### <Random Number Generation Method of Random Number Generation Device>

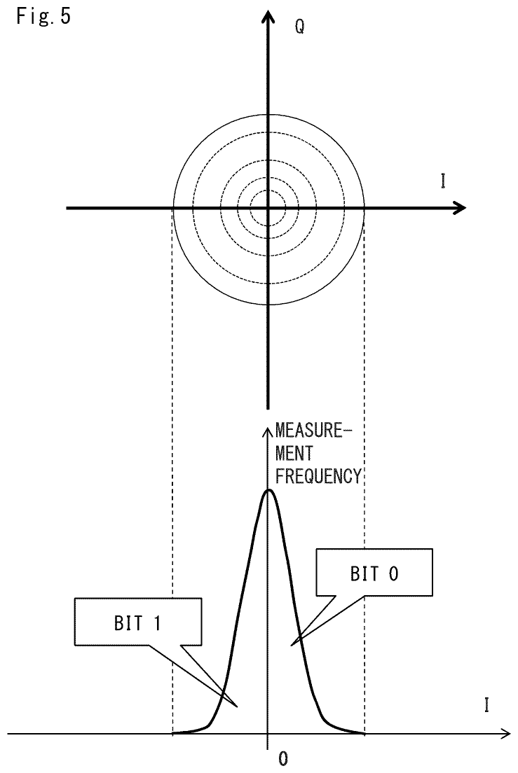

The random number generation device 120 of the transmitter 100 generates a random number by coherently detecting the phase and the amplitude in the vacuum state. The vacuum state is a state in which the average number of photons is zero, and the phase and amplitude of the vacuum state randomly vary with a constant dispersion value around zero. FIG. 5 illustrates an example of a measurement frequency distribution in a case where the phase and the amplitude in the vacuum state are coherently detected and projected on the I axis. As illustrated in FIG. 5, since the measurement frequency distribution randomly varies around zero amplitude, for example, a random number in which 0 and 1 are randomly selected can be generated by associating in a case where the amplitude takes a positive value with bit 0 and associating in a case where the amplitude takes a negative value with bit 1.

### <Configuration of Quantum Communication Unit>

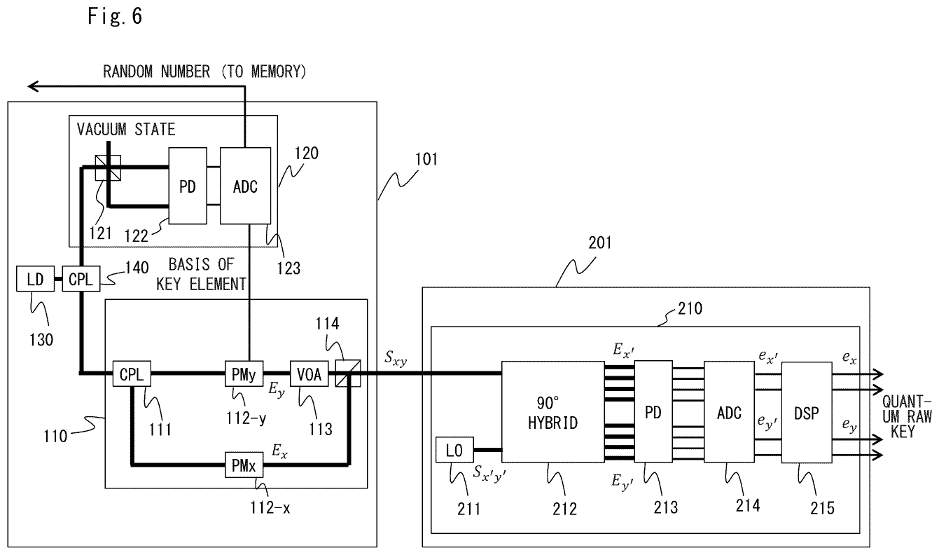

FIG. 6 is a block diagram illustrating a configuration example of the quantum communication unit 101 including the QKD optical communication device 110 and the random number generation device 120 in the transmitter 100 and the quantum communication unit 201 including the QKD optical communication device 210 in the receiver 200 according to the present example embodiment.

As illustrated in FIG. 6, the quantum communication unit 101 of the transmitter 100 includes the QKD optical communication device 110, the random number generation device 120, a light source (laser diode; LD) 130, and an optical coupler (Coupler; CPL) 140.

The light source 130 outputs light used by the QKD optical communication device 110 and the random number generation device 120. For example, the light source 130 is a laser diode that outputs laser light (coherent light). In the present example embodiment, since the light of the light source 130 is used as the weak light transmission of the QKD optical communication device 110 and the local light of the coherent detection of the random number generation device 120, the light source 130 outputs light with intensity required for these.

The optical coupler 140 is a branch unit that branches the light output from the light source 130 into light (first light) used by the random number generation device 120 and light (second light) used by the QKD optical communication device 110. The optical coupler 140 outputs the branched first light to the random number generation device 120 and outputs the second light to the QKD optical communication device 110. In the optical coupler 140, for example, a branching ratio between the first light to be branched into the random number generation device 120 and the second light to be branched into the QKD optical communication device 110 is set such that the light has the intensity required as the local light of the coherent detection in the random number generation device 120. For example, the intensity of the first light is greater than the intensity of the second light. The optical coupler 140 is not limited to the optical coupler, and may be configured by a beam splitter or other optical branching means.

The random number generation device 120 generates a random number by coherent detection using the light (first light) of the light source 130 branched by the optical coupler 140 as local light. The random number generation device 120 includes a half beam splitter (HBS) 121, a photodetector (PD) 122, and an analog to digital converter (ADC) 123. Since the random number generation device 120 can be configured by the half beam splitter 121, the photodetector 122, and the analog-digital converter 123, the random number generation device 120 can be configured to be smaller and less expensive than other random number generation devices using thermal noise measurement or the like. As long as a random number can be generated using the light of the light source, the random number may be generated by another method and configuration. For example, a random number may be generated by detecting light of a light source using an avalanche photodiode (APD).

The half beam splitter 121 and the photodetector 122 are detection units that perform coherent detection in a vacuum state using the light of the light source 130 branched by the optical coupler 140 as local light and acquire a phase amplitude value in the vacuum state. The half beam splitter 121 interferes the light of the light source 130 branched by the optical coupler 140 with the vacuum state of the photon number of 0, and branches the interfered light at a branching ratio of 1:1. The photodetector 122 detects a phase amplitude value of the two branched interference light beams and converts the phase amplitude value into an analog electric signal. The photodetector 122 may be a balance detector (balance receiver) that outputs a difference between two outputs of the half beam splitter 121.

The analog-digital converter 123 is a conversion unit that converts the result of the coherent detection by the half beam splitter 121 and the photodetector 122 into a random number. The analog-digital converter 123 converts a phase amplitude value output from the photodetector 122 into a 2-bit digital value to obtain a random number sequence expressing the key element and the basis information. The analog-digital converter 123 outputs a first random number sequence indicating the generated bit sequence to be transmitted and a second random number sequence indicating the basis in the phase modulation of the bit sequence to be transmitted to a phase modulator 112-y of the QKD optical communication device 110. The analog-digital converter 123 stores the generated random number in the memory 103.

The QKD optical communication device 110 includes an optical coupler (CPL) 111, a phase modulator (PM) 112-x, a phase modulator (PM) 112-y, a variable optical attenuator (VOA) 113, and a polarizing beam splitter (PBS) 114. The phase modulator 112-x and the phase modulator 112-y are also collectively referred to as a phase modulator 112.

The optical coupler 111 is a polarization separation unit that branches the light (second light) output from the light source 130 and branched by the optical coupler 140 into Y-polarized light (first polarized component) and X-polarized light (second polarized component). The optical coupler 111 outputs the branched X-polarized light to the phase modulator 112-x and outputs the Y-polarized light to the phase modulator 112-y.

The phase modulators 112-x and 112-y (phase modulator 112) are DP-QPSK modulation devices that modulate light according to a DP-QPSK modulation scheme. The phase modulator 112-x or 112-y is not limited to the DP-QPSK modulation method, and may perform phase modulation using other modulation methods. The phase modulator 112-x modulates the X-polarized light (second polarized component) out of the light branched by the optical coupler 111 to generate X-polarized signal light Eₓ, and outputs the generated signal light Eₓ to the polarization beam splitter 114. The phase modulator 112-y modulates Y-polarized light (first polarized component) out of the light branched by the optical coupler 111 to generate Y-polarized signal light E_{y}, and outputs the generated signal light E_{y} to the variable attenuator 113.

The phase modulator 112-y is a modulation unit that modulates the Y-polarized light branched by the optical coupler 111 based on the random number generated by the random number generation device 120. The phase modulator 112-y is a modulator that generates weak light to be transmitted, and receives a first random number sequence (key element) and a second random number sequence (basis) from the random number generation device 120. Both the first random number sequence and the second random number sequence can be expressed by a bit sequence, and the bits in the first random number sequence and the bits in the second random number sequence correspond to each other in a one-to-one manner. The phase modulator 112-y selects a basis indicated by a bit in the second random number sequence based on bits corresponding between the first random number sequence and the second random number sequence. Then, the phase modulator 112-y modulates the Y-polarized light in such a way that the bit value to be the element of the key indicated by the bit in the first random number sequence is represented by the selected basis. In this example, weak light is generated by modulating the Y-polarized wave component based on a random number, but weak light may be generated by modulating the X-polarized wave component.

The variable attenuator 113 attenuates the Y-polarized signal light E_{y} modulated by the phase modulator 112-y to a predetermined intensity, and outputs weak light of the attenuated signal light E_{y} to the polarization beam splitter 114. The variable attenuator 113 is associated with an example of a light intensity attenuator. The variable attenuator 113 attenuates the optical power of the Y-polarized signal light E_{y} to a weak state of performing a quantum behavior at about 1 photon/bit or less. This makes it possible to determine the presence or absence of eavesdropping by the principle of quantum mechanics.

The polarization beam splitter 114 is a polarization multiplex unit that polarization-multiplexes the X-polarized signal light Eₓ modulated by the phase modulator 112-x and the Y-polarized signal light E_{y} attenuated by the variable attenuator 113 to generate signal light S_{xy}=Eₓ+E_{y}. The QKD optical communication device 110 transmits the signal light S_{xy} obtained by the polarization multiplexing of the polarization beam splitter 114 to the receiver 200 via the quantum channel 300. For example, the QKD optical communication device 110 may include an optical transmission unit (not illustrated) that transmits the signal light S_{xy} to the QKD optical communication device 210.

The QKD optical communication device 210 included in the quantum communication unit 201 of the receiver 200 includes a local light source (LO) 211, a 90° hybrid (Hybrid) 212, a photodetector (PD) 213, an analog-digital converter (ADC) 214, and a digital signal processing circuit (DSP) 215. For example, the QKD optical communication device 210 may include an optical reception unit (not illustrated) that receives the signal light S_{xy} from the QKD optical communication device 110.

The local light source 211 outputs local light that the 90° hybrid 212 and the photodetector 213 use in coherent detection. For example, the local light source 211 is a laser diode that outputs laser light (coherent light).

The 90° hybrid 212 and the photodetector 213 are detection units that coherently detect the signal light S_{xy} received from the QKD optical communication device 110 using the local light output from the local light source 211. The 90° hybrid 212 causes the local light output from the local light source 211 and the signal light S_{xy} received by the receiver 200 to interfere with each other and reads out a quadrature-phase component. The 90° hybrid 212 projects the signal light S_{xy} received by the receiver 200 with the polarized wave and the phase of the output light S_{x′y′} of the local light source 211 to obtain X′ polarized signal light E_{x′} and Y′ polarized signal light E_{y′}, and outputs the generated signal light E_{x′} and E_{y′} to the photodetector 213.

The photodetector 213 is a conversion unit that converts the quadrature-phase component read by the 90° hybrid 212 into an electric signal. The photodetector 213 detects the signal light of E_{x′} and E_{y′} output from the 90° hybrid 212, converts the signal light into an analog electric signal, and outputs the converted electric signals of E_{x′} and E_{y′} to the analog-digital converter 214. Hereinafter, detection of signal light by the photodetector 213 is also referred to as detection.

The analog-digital converter 214 is a conversion unit that converts a result of coherent detection of the received signal light S_{xy} into a digital signal. The analog-digital converter 214 quantizes (analog-digital converts) the electric signal of the signal light E_{x′} and the electric signal of the signal light E_{y′} detected by the photodetector 213. A signal obtained by quantizing the electric signal of the signal light E_{x′} is also referred to as a digital electric signal e_{x′}. A signal obtained by quantizing the electric signal of the signal light E_{y′} is also referred to as a digital electric signal e_{y′}. The analog-digital converter 214 outputs the quantized digital electric signals e_{x′} and e_{y′} to the digital signal processing circuit 215.

The digital signal processing circuit 215 is a signal processing means that performs signal processing on the digital electric signal e_{x′} and the digital electric signal e_{y′} quantized by the analog-digital converter 214 to generate a quantum raw key. The digital signal processing circuit 215 performs polarization separation processing, wavelength difference correction, and phase difference correction of the signal light and the local light on the digital electric signal e_{x′} and the digital electric signal e_{y′}. The polarization separation processing performed by the digital signal processing circuit 215 is associated with coordinate conversion for converting a coordinate system including the polarization plane E_{x′} and the polarization plane E_{y′} into a coordinate system including the polarization plane in the X polarization and the polarization plane in the Y polarization. As a method by which the digital signal processing circuit 215 performs the polarization separation processing, a known method can be used. The digital signal processing circuit 215 generates a digital signal eₓ associated with the signal light Eₓ and a digital signal e_{y} associated with the signal light E_{y} by the polarization separation processing. The digital signal processing circuit 215 stores the bit sequence indicated by the digital signal e_{y} in the memory 203. This bit sequence is used as a quantization raw key, and becomes a quantum key through the basis collation (S12), the error correction (S13), and the confidentiality enhancement (S14) described above.

### <Operation of Quantum Key Carrier System>

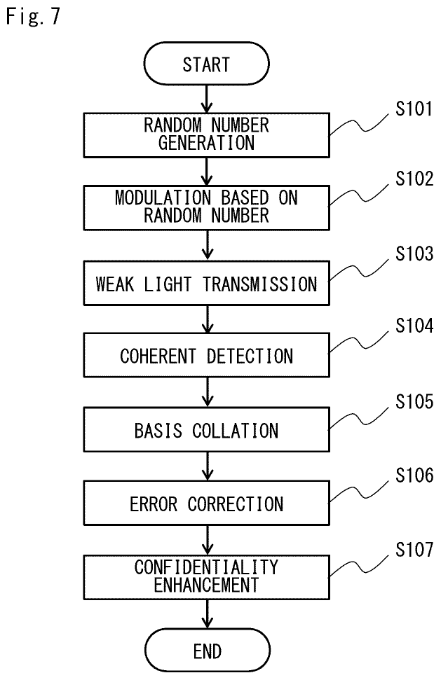

FIG. 7 illustrates an operation example of the quantum key carrier system 1 according to the present example embodiment.

As illustrated in FIG. 7, the transmitter 100 generates a random number (S101). The half beam splitter 121 and the photodetector 122 of the transmitter 100 perform coherent detection in a vacuum state for random number generation using the optical signal of the light source 130 as local light. The analog-digital converter 123 converts the output analog value from the photodetector 122 into a 2-bit digital value to generate a random number sequence, and outputs the generated first random number sequence and second random number sequence to the phase modulator 112. The analog-digital converter 123 stores the generated random number (for example, the first random number sequence and the second random number sequence) in the memory 103.

Next, the transmitter 100 performs modulation based on a random number (S102). The phase modulator 112 of the transmitter 100 phase-modulates a first polarization component of two orthogonal polarization components in transmission light based on a first random number sequence indicating a bit sequence to be transmitted and a second random number sequence indicating a basis in phase modulation of the bit sequence to be transmitted.

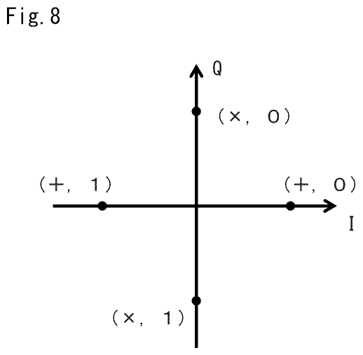

For example, the phase modulator 112-y phase-modulates the Y-polarized wave component of the transmission light based on the first random number sequence and the second random number sequence. FIG. 8 is an I-Q plan view illustrating a phase in a case where the phase modulator 112-y modulates light. In FIG. 8, the phase is expressed with reference to a positive direction of an I axis. The phase in the positive direction of the I axis is 0°, the phase in the positive direction of the Q axis is 90°, the phase in the negative direction of the I axis is 180°, and the phase in the negative direction of the Q axis is 270°. In the example in FIG. 8, the combination of the basis represented by the bit in the second random number sequence and the bit value serving as the element of the key represented by the bit in the first random number sequence is represented as (basis and key element).

In a case where the basis is a + (plus) basis, the phase modulator 112-y performs modulation using the I axis. Specifically, the phase modulator 112-y performs phase modulation of 0° in a case where (basis and key element)=(+, 0), and performs phase modulation of 180° in a case where (basis and key element)=(+, 1). In a case where the basis is a (cross) basis, the phase modulator 112-y performs modulation using the Q axis. Specifically, the phase modulator 112-y performs phase modulation of 90° in a case where (basis and key element)=(x, 0), and performs phase modulation of 270° in a case where (basis and key element)=(x, 1).

Next, the transmitter 100 transmits weak light (S103). The variable attenuator 113 of the transmitter 100 attenuates the light intensity of the modulated first polarization component. The polarization beam splitter 114 polarization-multiplexes the first polarization component after the light intensity attenuation and the second polarization component after the modulation, and outputs the obtained signal light to the quantum channel 300.

Next, the receiver 200 performs coherent detection (S104). The local light source 211 of the receiver 200 outputs local light for coherent detection. The 90° hybrid 212 reads out the quadrature-phase component by interfering the weak light component and the local light in the polarization-separated components received from the quantum channel 300. The photodetector 213 converts the read quadrature-phase component into an electric signal. The digital signal processing circuit 215 reads the first random number sequence from the electric signal, generates a quantum raw key, and stores the generated quantum raw key in the memory 203.

Next, the transmitter 100 and the receiver 200 perform basis collation (S105). The basis collation unit 204 of the receiver 200 performs basis collation processing using communication on the second channel between the transmitter 100 and the receiver 200 based on the generated quantum raw key and the second random number sequence to generate a selection key. The basis collation unit 104 of the transmitter 100 similarly generates the selection key by basis collation processing.

Next, the transmitter 100 and the receiver 200 perform error correction (S106). The error correction unit 205 of the receiver 200 performs error correction using communication in the second channel between the transmitter 100 and the receiver 200 on the generated selection key. Similarly, the error correction unit 105 of the transmitter 100 performs error correction on the selection key.

Next, the transmitter 100 and the receiver 200 perform confidentiality enhancement (S107). The confidentiality enhancement unit 206 of the receiver 200 generates a quantum key by performing confidentiality enhancement using communication on the second channel between the transmitter 100 and the receiver 200 on the selection key after error correction. Similarly, the confidentiality enhancement unit 106 of the transmitter 100 generates a quantum key by performing confidentiality enhancement on the selection key after error correction.

As described above, the quantum key distribution system according to the present example embodiment includes the quantum channel and the transmitter and the receiver communicatively connected by the classical channel having higher reliability than the quantum channel. In this transmitter, the light output of the light source is branched by an optical coupler and used as a transmission light source of the CV-QKD optical communication device and a light source for random number generation by coherent detection in a vacuum state. As a result, a transmission light source of the CV-QKD optical communication device and a light source for random number generation by coherent detection in a vacuum state can be shared to construct a system, in such a way that a small and simple quantum key distribution system can be achieved.

### Second Example Embodiment

Next, a second example embodiment of the present disclosure will be described. In the present example embodiment, an example will be described in which, in a receiver that performs quantum key transport, light sources used by a QKD optical communication device and a random number generation device are shared.

### <Configuration of Quantum Key Distribution System>

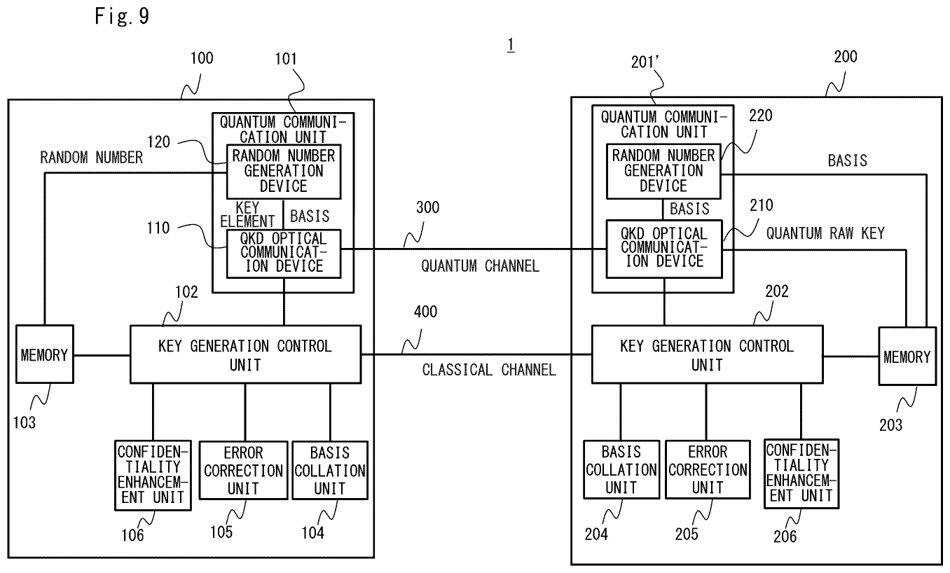

FIG. 9 is a block diagram illustrating a configuration example of the quantum key distribution system 1 according to the present example embodiment.

As shown in FIG. 9, in the present example embodiment, the receiver 200 includes a quantum communication unit 201′ instead of the quantum communication unit 201 of the first example embodiment. The quantum communication unit 201′ of the present example embodiment includes a random number generation device 220 in addition to the QKD optical communication device 210. Other configurations are similar to those of the first example embodiment. The receiver 200 may configure a quantum distribution system with a transmitter (quantum key distribution device) having a configuration different from that of the transmitter 100 of the first example embodiment.

The random number generation device 220 generates a random number used by the QKD optical communication device 210 and the key generation control unit 202. For example, the random number generation device 220 generates a random number (basis) by a random number generation method using coherent detection, outputs the generated random number to the QKD optical communication device 210, and stores the random number in the memory 203. The random number generated by the random number generation device 220 is used in coherent detection of the QKD optical communication device 210, and is used in key distillation such as basis collation, error correction, and confidentiality enhancement by the key generation control unit 202. The random number generating method of the random number generation device 220 is similar to that of the first example embodiment. In this example, an example in which the random number generated by the random number generation device 220 is used for both the coherent detection and the key distillation of the reception light will be described. However, the random number may be used for either the coherent detection or the key distillation of the reception light.

### <Configuration of Quantum Communication Unit>

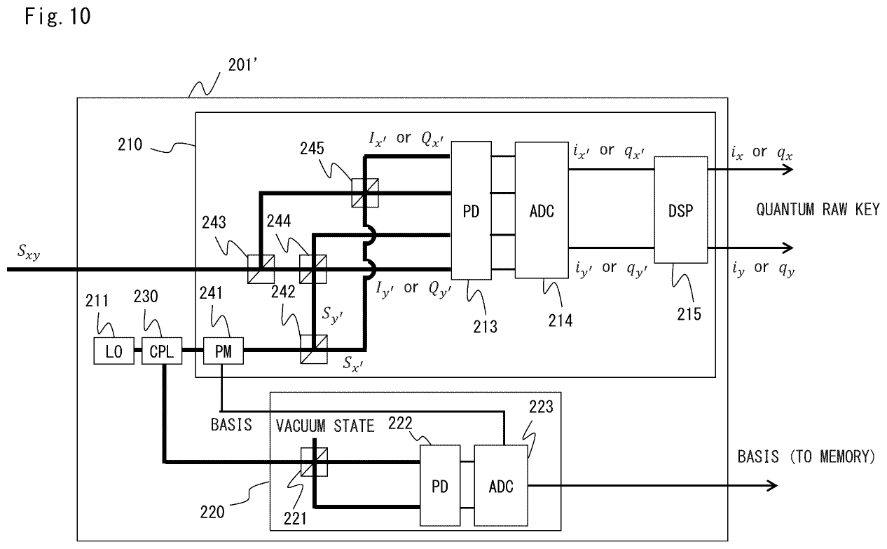

FIG. 10 is a block diagram illustrating a configuration example of the quantum communication unit 201′ of the receiver 200 according to the present example embodiment.

In the present example embodiment, in order to improve the degradation of the signal S/N due to the IQ both-axis measurement, a method is applied in which the receiver randomly selects the I axis, the Q axis, or a random number, projects the state to one of the axes on one side and measures the state, and only the measurement result in which the bases of transmission and reception match is adopted afterwards to generate the quantum key. That is, in the present example embodiment, a part of the light of the local light source for quantum light readout of the receiver 200 is branched, and random number generation is performed by coherent detection in a vacuum state. The receiver 200 randomly selects one of the I axis, the Q axis, and the random number, projects the state to one of the axes, and measures the state. Only the measurement result in which the transmission and reception bases match is adopted afterwards to generate the quantum key.

As illustrated in FIG. 10, the quantum communication unit 201′ of the receiver 200 includes a QKD optical communication device 210, a random number generation device 220, a local light source (LO) 211, and an optical coupler (CPL) 230.

The local light source 211 outputs local light. In the present example embodiment, since the local light of the local light source 211 is used as the local light of the coherent detection of the QKD optical communication device 210 and the local light of the coherent detection of the random number generation device 220, the local light source 211 outputs the local light having the intensity required for these.

The optical coupler 230 is a branch unit that branches light output from the local light source 211 into local light (first local light) used by the random number generation device 220 and local light (second local light) used by the QKD optical communication device 210. The optical coupler 230 outputs the branched first local light to the random number generation device 220 and outputs the second local light to the QKD optical communication device 210. In the optical coupler 230, for example, a branching ratio between the first local light to be branched into the random number generation device 220 and the second local light to be branched into the QKD optical communication device 210 is set such that the local light has the intensity required as the local light of the coherent detection in the QKD optical communication device 210 and the local light of the coherent detection in the random number generation device 220. The optical coupler 230 is not limited to the optical coupler, and may be configured by a beam splitter or other optical branching means.

The random number generation device 220 generates a random number by coherent detection using the local light (first local light) of the local light source 211 branched by the optical coupler 230. The configuration of the random number generation device 220 is similar to that of the random number generation device 120 of the transmitter 100. That is, the random number generation device 220 includes a half beam splitter (HBS) 221, a photodetector (PD) 222, and an analog-digital converter (ADC) 223. Similarly to the random number generation device 120 of the transmitter 100, the random number generation device 220 can be configured by the half beam splitter 221, the photodetector 222, and the analog-digital converter 223, and thus can be configured to be smaller and less expensive than other random number generation devices using thermal noise measurement or the like. As long as a random number can be generated using the light of the light source, the random number may be generated by another method and configuration. For example, the random number may be generated by detecting the light of the light source using the APD.

The half beam splitter 221 and the photodetector 222 are detection units that perform coherent detection in a vacuum state using one local light branched by the optical coupler 230 to acquire a phase amplitude value in the vacuum state for random number generation. The half beam splitter 221 causes interference between a vacuum state with a photon number of 0 and the local light of the local light source 211 branched by the optical coupler 230, and branches the interfering light at a branching ratio of 1:1. The photodetector 222 detects a phase amplitude value of the two branched interference light beams and converts the phase amplitude value into an analog electric signal. The photodetector 222 may be a balance detector (balance receiver) that outputs a difference between two outputs of the half beam splitter 221.

The analog-digital converter 223 is a conversion unit that converts the result of the coherent detection by the half beam splitter 221 and the photodetector 222 into a random number. The analog-digital converter 223 converts the phase amplitude value output from the photodetector 222 into a 1-bit digital value to obtain a random number representing the basis. The analog-digital converter 223 outputs the generated random number to the phase modulator 241 of the QKD optical communication device 210. The analog-digital converter 223 stores the generated random number in the memory 203.

The QKD optical communication device 210 includes a phase modulator (PM) 241, polarization beam splitters (PBS) 242 and 243, and half beam splitters (HBS) 244 and 245, in addition to a photodetector (PD) 213, an analog-to-digital converter (ADC) 214, and a digital signal processing circuit (DSP) 215.

For example, the polarization beam splitter (PBS) 243, the half beam splitters (HBS) 244 and 245 configure a 90° hybrid for coherent detection. The 90° hybrid and photodetector 213 is a detection unit that coherently detects the signal light S_{xy} received from the QKD optical communication device 110 based on the local light (second local light) of the local light source 211 branched by the optical coupler 230 and the random number generated by the random number generation device 220.

The phase modulator 241 performs phase modulation for projecting the other local light branched by the optical coupler 230 onto the I axis or the Q axis according to the random number output (basis) from the analog-digital converter 223 of the random number generation device 220. The modulation scheme may be any phase modulation scheme. The phase modulator 241 outputs the local light phase-modulated based on the random number to the polarization beam splitter 242.

The polarization beam splitter 242 polarization-separates the phase-modulated local light (second local light) output from the phase modulator 241 into polarization components S_{x′} and S_{y′}, outputs the polarization component S_{x′} of the polarization-separated X polarized wave to the half beam splitter 245, and outputs the polarization component S_{y′} of the Y polarized wave to the half beam splitter 244.

The polarization beam splitter 243 is a polarization separation unit that polarization-separates the signal light output from the quantum communication unit 101 of the transmitter 100 into Y-polarized light (first polarized component) and X-polarized light (second polarized component). The polarization beam splitter 243 outputs the polarization-separated X-polarized light to the half beam splitter 245, and outputs the Y-polarized light to the half beam splitter 244.

The half beam splitters 244 and 245 coherently detect weak light received from the transmitter 100 with local light (second local light after phase modulation). The half beam splitters 244 and 245 cause the second local light after the phase modulation and the signal light S_{xy} received by the receiver 200 to interfere with each other and read out a quadrature-phase component. The half beam splitter 244 performs coherent detection of the Y component of the signal light (weak light) from the polarization beam splitter 243 by the polarization component S_{y′} of the local light after the phase modulation from the polarization beam splitter 242, and outputs an I-axis projection component light signal I_{y′} or a Q-axis projection component light signal Q_{y′} of the obtained signal light to the photodetector 213. The half beam splitter 245 performs coherent detection of the X component of the signal light (weak light) from the polarization beam splitter 243 by the polarization component S_{x′} of the local light after the phase modulation from the polarization beam splitter 242, and outputs an I-axis projection component light signal I_{x′} or a Q-axis projection component light signal Q_{x′} of the obtained signal light to the photodetector 213.

The photodetector 213 converts the I-axis projection component optical signals I_{x′} and I_{y′} or the Q-axis projection component optical signals Q_{x′} and Q_{y′} output from the half beam splitters 244 and 245 into electric signals, and outputs the obtained I-axis projection component analog electric signals of i_{x′} and i_{y′} or the obtained Q-axis projection component analog electric signals of q_{x′} and q_{y′} to the analog-to-digital converter 214.

The analog-digital converter 214 analog-digital converts the I-axis projection component analog electric signals of i_{x′} and i_{y′} or the Q-axis projection component analog electric signals of q_{x′} and q_{y′} converted by the photodetector 213, and outputs the obtained I-axis projection component digital electric signals i_{x′} and i_{y′} or the obtained Q-axis projection component digital electric signals q_{x′} and q_{y′} to the digital signal processing circuit 215.

The digital signal processing circuit 215 performs signal processing similarly to the first example embodiment on the I-axis projection component digital electric signals i_{x′} and i_{y′} or the Q-axis projection component digital electric signals q_{x′} and q_{y′} analog-digital converted by the analog-digital converter 214, reads the first random number sequence iₓ, i_{y} or qₓ and q_{y}, and generates a quantum raw key. The digital signal processing circuit 215 stores the generated quantum raw key in the memory 203. The stored quantum raw key becomes the quantum key through basis collation (S12), error correction (S13), and confidentiality enhancement (S14) as in the first example embodiment.

As described above, in the present example embodiment, the local light output from the local light source is branched by the optical coupler in the receiver of the quantum key carrier system and used for the local light for coherent detection of the CV-QKD optical communication device and the local light for coherent detection of the random number generation device. As a result, a system can be constructed by sharing the light source for coherent detection of the CV-QKD optical communication device and the light source for coherent detection of the random number generation device, so that a small and simple quantum key distribution system can be achieved.

The present disclosure is not limited to the above example embodiments, and can be appropriately changed without departing from the scope.

Each configuration in the above-described example embodiments may be implemented by hardware, software, or both, and may be implemented by one piece of hardware or software or by a plurality of pieces of hardware or software. Each function (key generation control unit, basis collation unit, error correction unit, confidentiality enhancement unit, and the like) of each device (transmitter, receiver, etc.) may be achieved by a computer having a processor such as a CPU and a memory which is a storage device. For example, a program for performing the method (quantum key distribution method or the like) in the example embodiment may be stored in a memory, and each function may be achieved by executing the program stored in the memory by a processor.

These programs include a group of commands (or software codes) causing a computer to perform one or more of the functions described in the example embodiments in a case of being read by the computer. The program may be stored in a non-transitory computer readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. As an example and not by way of limitation, the transitory computer-readable medium or the communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described as the following supplementary notes, but are not limited to the following supplementary notes.

### (Supplementary Note 1)

A quantum key distribution device including:
a light source for outputting light;
a branch means for branching the light output from the light source into first light and second light;
a random number generation means for generating a random number based on the first light;
a modulation means for modulating the second light based on the random number; and
an optical transmission means for transmitting the modulated second light as a quantum optical signal to another quantum key distribution device.

### (Supplementary Note 2)

The quantum key distribution device according to Supplementary Note 1, in which the random number generation means generates the random number by coherent detection with the first light as local light.

### (Supplementary Note 3)

The quantum key distribution device according to Supplementary Note 2, in which the random number generation means includes:
a detection means for coherently detecting a vacuum state with the first light as the local light; and
a conversion means for converting a result of the coherent detection into a random number.

### (Supplementary Note 4)

The quantum key distribution device according to Supplementary Note 3, in which
the detection means includes:
a half beam splitter that causes the first light and the vacuum state to interfere with each other and outputs two interference lights; and
a photodetector that converts the two interference light beams into electric signals, and
the conversion means is an analog-digital converter that performs analog-digital conversion on the electric signals of the two interference lights and outputs the random number.

### (Supplementary Note 5)

The quantum key distribution device according to any one of Supplementary Notes 1 to 4, in which
the random number generation means generates a first random number sequence indicating a bit sequence to be transmitted and a second random number sequence indicating a basis in phase modulation of the bit sequence to be transmitted, and
the modulation means phase-modulates the second light based on the first random number sequence and the second random number sequence.

### (Supplementary Note 6)

The quantum key distribution device according to Supplementary Note 5, in which the modulation means is a modulator that performs phase modulation by a Dual Polarization Quadrature Phase Shift Keying (DP-QPSK) method.

### (Supplementary Note 7)

The quantum key distribution device according to any one of Supplementary Notes 1 to 6, further including an attenuation means for attenuating the light intensity of the modulated second light to a predetermined intensity to obtain weak light,
in which the optical transmission means transmits the weak light.

### (Supplementary Note 8)

The quantum key distribution device according to any one of Supplementary Notes 1 to 7, further including a polarization separation means for separating the branched second light into a first polarization component and a second polarization component,
in which the modulation means modulates the first polarization component based on the random number.

### (Supplementary Note 9)

The quantum key distribution device according to Supplementary Note 8, further including a polarization multiplex means for polarization-multiplexing the modulated first polarization component and the second polarization component,
in which the optical transmission means transmits the polarization-multiplexed optical signal.

### (Supplementary Note 10)

The quantum key distribution device according to Supplementary Note 9, further including:
a storage means for storing the generated random number; and
a key distillation means for performing key distillation processing using the stored random number.

### (Supplementary Note 11)

A quantum key distribution device including:
an optical reception means for receiving a quantum optical signal from another quantum key distribution device;
a light source for outputting local light;
a branch means for branching the local light output from the light source into first local light and second local light;
a random number generation means for generating a random number based on the first local light; and
a detection means for coherently detecting the received quantum optical signal based on the second local light and the random number.

### (Supplementary Note 12)

The quantum key distribution device according to Supplementary Note 11, in which the random number generation means generates the random number by coherent detection using the first local light.

### (Supplementary Note 13)

The quantum key distribution device according to Supplementary Note 12, in which the random number generation means includes:
a detection means for coherently detecting a vacuum state using the first local light; and
a conversion means for converting the result of the coherent detection into a random number.

### (Supplementary Note 14)

The quantum key distribution device according to Supplementary Note 13, in which
the detection means includes:
a half beam splitter that causes the first local light and the vacuum state to interfere with each other and outputs two interference lights; and
a photodetector for converting the two interference light beams into electric signals, and
the conversion means is an analog-digital converter that performs analog-digital conversion on the electric signals of the two interference lights and outputs the random number.

### (Supplementary Note 15)

The quantum key distribution device according to any one of Supplementary Notes 11 to 14, further including a modulation means for phase-modulating the second local light based on the random number,
in which the detection means coherently detects the received quantum optical signal based on the phase-modulated second local light.

### (Supplementary Note 16)

The quantum key distribution device according to Supplementary Note 15, in which
the detection means includes:
a hybrid means for reading out a quadrature-phase component by causing the received quantum optical signal and the phase-modulated second local light to interfere with each other; and
a conversion means for converting the read quadrature-phase component into an electric signal.

### (Supplementary Note 17)

The quantum key distribution device according to any one of Supplementary Notes 11 to 16, further including:
a conversion means for converting the coherent detection result into a digital signal; and
a signal processing means for generating a quantum raw key based on the converted digital signal.

### (Supplementary Note 18)

The quantum key distribution device according to Supplementary Note 17, further including:
a storage means for storing the generated random number and the generated quantum raw key; and
a key distillation means for performing key distillation processing using the stored random number and quantum raw key.

### (Supplementary Note 19)

A quantum key distribution system including:
a first quantum key distribution device and a second quantum key distribution device that are communicatively connected,
in which the first quantum key distribution device includes:
a light source for outputting light;
a branch means for branching light output from the light source into first light and second light;
a random number generation means for generating a random number based on the first light;
a modulation means for modulating the second light based on the random number; and
an optical transmission means for transmitting the modulated second light as a quantum optical signal to the second quantum key distribution device.

### (Supplementary Note 20)

A quantum key distribution system including: a first quantum key distribution device and a second quantum key distribution device that are communicatively connected,
in which the second quantum key distribution device includes:
an optical reception means for receiving a quantum optical signal from the first quantum key distribution device;
a light source for outputting local light;
a branch means for branching the local light output from the light source into first local light and second local light;
a random number generation means for generating a random number based on the first local light; and
a detection means for coherently detecting the received quantum optical signal based on the second local light and the random number.

### (Supplementary Note 21)

A quantum key distribution method in a quantum key distribution device, including:
branching light output from a light source into first light and second light;
generating a random number based on the first light;
modulating the second light based on the random number; and
transmitting the modulated second light as a quantum optical signal to another quantum key distribution device.

### (Supplementary Note 22)

A quantum key distribution method in a quantum key distribution device, the method including:
receiving a quantum optical signal from another quantum key distribution device;
branching the local light output from the light source into first local light and second local light;
generating a random number based on the first local light; and
coherently detecting the received quantum optical signal based on the second local light and the random number.

### (Supplementary Note 23)

A quantum key distribution system including: a first communication device and a second communication device that are communicatively connected by a first channel and a second channel that is more reliable than the first channel, in which
the first communication device includes:
a light source for quantum optical communication and random number generation;
an optical coupler that divides an optical output of the light source for use in a quantum optical communication device and a random number generation device;
a DP-QPSK modulation device that performs phase modulation on a first polarization component of two orthogonal polarization components in transmission light and modulates a second polarization component, which is another polarization component, into a signal indicating a second random number sequence, based on a first random number sequence indicating a bit sequence to be transmitted and a second random number sequence indicating a basis in phase modulation of the bit sequence to be transmitted, as a quantum optical communication device;
a light intensity attenuator that attenuates light intensity of the modulated first polarization component to make weak light;
a polarization beam splitter that polarization-multiplexes the first polarization component in which the light intensity is attenuated and the modulated second polarization component, and outputs obtained signal light to the first channel;
a half beam splitter and a photodetector for coherent detection of a vacuum state as a random number generation device; and
an analog-digital converter that converts an analog value subjected to coherent detection into a 2-bit digital value to generate the first random number sequence and the second random number sequence, and the second communication device includes:
a local light source for coherent detection;
a 90° hybrid that causes the weak light and the local light to interfere with each other to read out a quadrature-phase component;
a photodetector that converts the read quadrature-phase component into an electric signal;
an analog-to-digital converter that converts an analog output of the photodetector into a digital signal;
a signal processing means that reads the first random number sequence from the digital signal and generate a quantum raw key;
a basis collation means that generates a selection key by performing basis collation processing using communication on the second channel between the first communication device and the second communication device based on the generated quantum raw key and the second random number sequence;
an error correction means that performs error correction using communication on the second channel between the first communication device and the second communication device on the generated selection key; and
a confidentiality enhancement means that generates a quantum key by performing confidentiality enhancement on the selection key after error correction using communication on the second channel between the first communication device and the second communication device.

### REFERENCE SIGNS LIST

1 quantum key distribution system
10 first quantum key distribution device
11 light source
12 branch unit
13 random number generation unit
14 modulation unit
15 optical transmission unit
20 second quantum key distribution device
21 optical reception unit
22 light source
23 branch unit
24 random number generation unit
25 detection unit
100 transmitter
101 quantum communication unit
102 key generation control unit
103 memory
104 basis collation unit
105 error correction unit
106 confidentiality enhancement unit
110 QKD optical communication device
111 optical coupler
112, 112-x, 112-y phase modulator
113 variable attenuator
114 polarization beam splitter
120 random number generation device
121 half beam splitter
122 photodetector
123 analog-to-digital converter
130 light source
140 optical coupler
200 receiver
201, 201′ quantum communication unit
202 key generation control unit
203 memory
204 basis collation unit
205 error correction unit
206 confidentiality enhancement unit
210 QKD optical communication device
211 local light source
212 90° hybrid
213 photodetector
214 analog-to-digital converter
215 digital signal processing circuit
220 random number generation device
221 half beam splitter
222 photodetector
223 analog-to-digital converter
230 optical coupler
241 phase modulator
242, 243 polarization beam splitter
244, 245 half beam splitter
300 quantum channel
400 classical channel

What is claimed is:

1. A quantum key distribution device comprising:
a light source for outputting light;
a brancher branching the light output from the light source into first light and second light;
a random number generator generating a random number based on the first light;
a modulator modulating the second light based on the random number; and
an optical transmitter transmitting the modulated second light as a quantum optical signal to another quantum key distribution device.

2. The quantum key distribution device according to claim 1, wherein the random number generator generates the random number by coherent detection with the first light as local light.

3. The quantum key distribution device according to claim 2,
wherein the random number generator includes
a detector coherently detecting a vacuum state with the first light as the local light, and
a converter converting a result of the coherent detection into a random number.

4. The quantum key distribution device according to claim 3, wherein
the detector includes
a half beam splitter that causes the first light and the vacuum state to interfere with each other and outputs two interference lights, and
a photodetector that converts the two interference light beams into electric signals, and
the converter is an analog-digital converter that performs analog-digital conversion on the electric signals of the two interference lights and outputs the random number.

5. The quantum key distribution device according to claim 1, wherein
the random number generator generates a first random number sequence indicating a bit sequence to be transmitted and a second random number sequence indicating a basis in phase modulation of the bit sequence to be transmitted, and
the modulator phase-modulates the second light based on the first random number sequence and the second random number sequence.

6. The quantum key distribution device according to claim 5, wherein the modulator is a modulator that performs phase modulation by a Dual Polarization Quadrature Phase Shift Keying (DP-QPSK) method.

7. The quantum key distribution device according to claim 1, further comprising an attenuator for attenuating the light intensity of the modulated second light to a predetermined intensity to obtain weak light,
wherein the optical transmitter transmits the weak light.

8. The quantum key distribution device according to claim 1, further comprising a polarization separator for separating the branched second light into a first polarization component and a second polarization component,
wherein the modulator modulates the first polarization component based on the random number.

9. The quantum key distribution device according to claim 8, further comprising a polarization multiplexer polarization-multiplexing the modulated first polarization component and the second polarization component,
wherein the optical transmitter transmits the polarization-multiplexed optical signal.

10. The quantum key distribution device according to claim 9, further comprising:
a memory storing the generated random number; and
a key distillator performing key distillation processing using the stored random number.

11. A quantum key distribution device comprising:
an optical receiver receiving a quantum optical signal from another quantum key distribution device;
a light source for outputting local light;
a brancher branching the local light output from the light source into first local light and second local light;
a random number generator generating a random number based on the first local light; and
a first detector coherently detecting the received quantum optical signal based on the second local light and the random number.

12. The quantum key distribution device according to claim 11, wherein the random number generator generates the random number by coherent detection using the first local light.

13. The quantum key distribution device according to claim 12,
wherein the random number generator includes
a second detector coherently detecting a vacuum state using the first local light, and
a converter converting the result of the coherent detection into a random number.

14. The quantum key distribution device according to claim 13, wherein
the second detector includes:
a half beam splitter that causes the first local light and the vacuum state to interfere with each other and outputs two interference lights; and
a photodetector for converting the two interference light beams into electric signals, and
the converter is an analog-digital converter that performs analog-digital conversion on the electric signals of the two interference lights and outputs the random number.

15. The quantum key distribution device according to claim 11, further comprising a modulator phase-modulating the second local light based on the random number,
wherein the first detector coherently detects the received quantum optical signal based on the phase-modulated second local light.

16. The quantum key distribution device according to claim 15,
wherein the first detector includes:
a hybrid reading out a quadrature-phase component by causing the received quantum optical signal and the phase-modulated second local light to interfere with each other; and
a converter converting the read quadrature-phase component into an electric signal.

17. The quantum key distribution device according to claim 11, further comprising:
a converter converting the coherent detection result into a digital signal; and
a signal processer generating a quantum raw key based on the converted digital signal.

18. The quantum key distribution device according to claim 17, further comprising:
a memory storing the generated random number and the generated quantum raw key; and
a key distillator performing key distillation processing using the stored random number and quantum raw key.

19. A quantum key distribution system comprising
a first quantum key distribution device and a second quantum key distribution device that are communicatively connected,
wherein the first quantum key distribution device includes
a first light source for outputting light,
a first brancher branching light output from the first light source into first light and second light,
a first random number generator generating a first random number based on the first light,
a modulator modulating the second light based on the first random number, and
an optical transmitter transmitting the modulated second light as a quantum optical signal to the second quantum key distribution device,
the second quantum key distribution device includes
an optical receiver receiving the quantum optical signal from the first quantum key distribution device,
a second light source for outputting local light,
a second brancher branching the local light output from the second light source into first local light and second local light,
a second random number generator generating a second random number based on the first local light, and
a detector coherently detecting the received quantum optical signal based on the second local light and the second random number.

20-22. (canceled)
